(19) United States
(12) Patent Application Publication
(10) Pub. No.: US 2023/0044809 A1
(43) Pub. Date: Feb. 9, 2023

(54) WATER-BASED ACRYLIC RESIN AND METHOD FOR PRODUCING THE SAME

(71) Applicant: NAN YA PLASTICS CORPORATION, Taipei (TW)

(72) Inventors: TE-CHAO LIAO, TAIPEI (TW); SEN-HUANG HSU, TAIPEI (TW); Hui-Chun Chuang, TAIPEI (TW)

(21) Appl. No.: 17/853,930

(22) Filed: Jun. 30, 2022

(30) Foreign Application Priority Data
Aug. 2, 2021 (TW) 110128257

(51) Int. Cl. C08F 283/06

(52) U.S. Cl. CPC C08F 283/06

(57) ABSTRACT

A water-based acrylic resin and a method for producing the same are provided. The water-based acrylic resin includes a polymerizable composition. The polymerizable composition includes deionized water, a reactive emulsifier, a first acrylic monomer, a second acrylic monomer, a third acrylic monomer, a fourth acrylic monomer, and an acrylic polyol. The reactive emulsifier is a nonylphenyl-free reactive emulsifier. The first acrylic monomer is an alkyl-containing (meth)acrylate. The second acrylic monomer is a hydroxyl-containing (meth)acrylate. The third acrylic monomer is a carboxyl-containing (meth)acrylate. The fourth acrylic monomer is an ethylenically-unsaturated-functional-groups-containing (meth)acrylate. The acrylic polyol is one or both of a hydroxyl-containing polyester acrylic polyol and a hydroxyl-containing polyether acrylic polyol.

### CROSS-REFERENCE TO RELATED PATENT APPLICATION

This application claims the benefit of priority to Taiwan Patent Application No. 110128257, filed on Aug. 2, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an acrylic resin, and more particularly to a water-based acrylic resin and a method for producing the same.

### BACKGROUND OF THE DISCLOSURE

In the related art, most conventional synthetic leather treatment agents are solvent-based treatment agents. The solvent-based treatment agents have a high amount of volatile organic compound (VOC) emission. With the rise of environmental awareness and due to requirements of environmental protection laws and regulations, reducing emission of volatile organic compounds has become one of the objectives for research and development in the area of synthetic leather treatment agents. In order to reduce the emission of the volatile organic compounds, water-based treatment agents are currently available on the market. However, when the water-based treatment agents are used on synthetic leather products, there is often the technical problem of poor flex resistance.

### SUMMARY OF THE DISCLOSURE

In response to the above-referenced technical inadequacies, the present disclosure provides a water-based acrylic resin and a method for producing the same. The water-based acrylic resin is suitable for manufacturing of synthetic leather and has flex resistance properties.

In one aspect, the present disclosure provides a water-based acrylic resin that includes a polymerizable composition. The polymerizable composition includes deionized water, a reactive emulsifier, a plurality of acrylic monomers, and an acrylic polyol. The reactive emulsifier is a nonylphenyl-free reactive emulsifier. The acrylic monomers include a first acrylic monomer, a second acrylic monomer, a third acrylic monomer, and a fourth acrylic monomer. The first acrylic monomer is an alkyl-containing (meth)acrylate. The second acrylic monomer is a hydroxyl-containing (meth)acrylate. The third acrylic monomer is a carboxyl-containing (meth)acrylate. The fourth acrylic monomer is an ethylenically-unsaturated-functional-groups-containing (meth)acrylate. The acrylic polyol is a hydroxyl-containing polyester acrylic polyol and/or a hydroxyl-containing polyether acrylic polyol. The water-based acrylic resin is in a form of emulsion, and a solid content of the water-based acrylic resin is between 30% and 50% by weight.

In certain embodiments, the nonylphenyl-free reactive emulsifier is at least one of SR-10, SR-20, and SR-1025 sold by ADEKA.

In certain embodiments, the nonylphenyl-free reactive emulsifier has an additional number of moles of ethylene oxide (EO) between 10 and 20, a purity between 10% and 25%, a hue (APHA) between 2(G) and 5(G), a pH value between 6.5 and 7.5, and a viscosity not greater than 12,000 (mPas, 25° C.).

In certain embodiments, the first acrylic monomer, the second acrylic monomer, the third acrylic monomer, and the fourth acrylic monomer are formed into an acrylic resin after a polymerization reaction, and the acrylic resin is a main matrix material of the water-based acrylic resin.

In certain embodiments, the first acrylic monomer is selected from a group consisting of methyl methacrylate (MMA), n-butyl-methyl acrylate (n-BMA), 2-ethylhexyl ester (2-EHA), and butyl acrylate (BA). The second acrylic monomer is 2-hydroxyethyl methacrylate (2-HEMA). The third acrylic monomer is selected from a group consisting of acrylic acid (AA) and methacrylic acid (MAA). The fourth acrylic monomer is selected from a group consisting of styrene (SM) and isobornyl methacrylate (IBOMA).

In certain embodiments, the acrylic polyol is at least one of SPECFLEX™ NC 701, VORALUX™ HF 4001, VORALUX™ HN 395, VORALUX™ WH 4043, VORANOL™ 4053, and VORANOL™ CP 6001 sold by Dow Chemical Company.

In certain embodiments, an acid value (KOH) of the acrylic polyol is between 20 mg KOH/g and 35 mg KOH/g, and a weight average molecular weight (Mw) of the acrylic polyol is between 3,000 and 12,000.

In certain embodiments, a weight ratio of the plurality of acrylic monomers, the acrylic polyol, and the reactive emulsifier is between 15 to 20:1 to 2:1 to 2.

In certain embodiments, a molecular structure of the water-based acrylic resin has a polar group which is a hydroxyl group (—OH) and/or an ester group (—COOR).

In certain embodiments, the water-based acrylic resin is configured to be coated on an artificial leather to obtain a test sample, the test sample is then mounted on a tortuosity testing machine, and a tortuous test is performed on the test sample at an angle of 22.5° and a frequency of 100 times per minute for 300 minutes. The test sample is free of damage after the tortuous test.

In another aspect, the present disclosure provides a method for producing a water-based acrylic resin, which includes: adding deionized water, sodium bicarbonate, and sodium dodecyl-benzene sulfonate into a first reaction tank and stirring uniformly to form an initial reaction material; heating the initial reaction material to a first heating temperature; then adding a first hydrophilic initial aqueous solution formed by sodium persulfate and deionized water into the initial reaction material; adding deionized water, nonylphenyl-free reactive emulsifier, alkyl-containing (meth)acrylate, hydroxyl-containing (meth)acrylate, carboxyl-containing (meth)acrylate and ethylenically-unsaturated-functional-groups-containing (meth)acrylate with hydroxyl-containing polyester acrylic polyol and/or hydroxyl-containing polyether acrylic polyol into the first reaction tank, and then uniformly mixing with the initial reaction material to form a pre-emulsion; taking a part of the pre-emulsion from the first reaction tank and adding the part of the pre-emulsion into a second reaction tank to form a seed emulsion; and maintaining the seed emulsion at the first heating temperature, and adding another part of the pre-emulsion into the second reaction tank to react in a droplet manner, in which a second hydrophilic initial aqueous solution formed by sodium persulfate and deionized water is added into the second reaction tank in the droplet manner, and a temperature of the seed emulsion is sequentially raised to a second heating temperature and lowered to a cooling temperature, and then a pH value of the seed emulsion is adjusted to obtain the water-based acrylic resin.

In certain embodiments, the first heating temperature is between 74° C. and 78° C., the second heating temperature is between 78° C. and 82° C., and the cooling temperature is not greater 40° C.

Therefore, in the water-based acrylic resin and the method for producing the same provided by the present disclosure, through a material selection of the polymerizable composition, the water-based acrylic resin has good flex resistance and a low amount of volatile organic compound (VOC) emission.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Water-Based Acrylic Resin

An embodiment of the present disclosure provides a water-based acrylic resin, which has good flex resistance and a low amount of volatile organic compound (VOC) emission when being used on synthetic leather products. The water-based acrylic resin of the present embodiment can effectively solve existing technical problems in the related art.

In the present embodiment, the water-based acrylic resin is formed by using a special synthesis technique, which includes bonding a reactive emulsifier and one or both of a polyester polyol and a polyether polyol onto a molecular structure of an acrylic polymer during a synthesis process. Furthermore, the water-based acrylic resin can be added with functional monomers during the synthesis process.

By virtue of the aforementioned synthesis technique, the molecular structure of the water-based acrylic resin can have polar groups such as hydroxyl groups (—OH) and ester groups (—COOR), thereby improving a crosslinking degree and cohesion of the water-based acrylic resin. Accordingly, the water-based acrylic resin can have good bending resistance, and thus has a wide range of applications. Furthermore, the water-based acrylic resin has a low amount of volatile organic compound (VOC) emission, and is thus favorable for environmental protection.

More specifically, the water-based acrylic resin is formed by a polymerizable composition, an initial reaction material, a first hydrophilic initial aqueous solution, and a second hydrophilic initial aqueous solution during a polymerization reaction under a specific reaction condition.

The polymerizable composition includes deionized water, a reactive emulsifier, a plurality of acrylic monomers, and an acrylic polyol.

In the polymerizable composition, the deionized water is a solvent component. All of the reactive emulsifier, the acrylic monomers, and the acrylic polyol are solute components and participate in the polymerization reaction.

The deionized water is natural water from which cations of elements such as sodium, calcium, iron, copper and anions of elements such as chlorine and bromine are removed. In other words, apart from H₃O⁺ and OH⁻, the deionized water does not include any other ionic components. However, the deionized water can still include some organic matter in a non-ionic form. The deionized water can be produced through processes such as ion exchange separation.

Furthermore, the reactive emulsifier is an anionic reactive emulsifier, and is preferably a nonylphenyl-free reactive emulsifier.

The nonylphenyl-free reactive emulsifier can be, for example, an environmental hormone-corresponding reactive surfactant sold by ADEKA Corporation (such as the model SR-10, the model SR-20, or the model SR-1025), but the present disclosure is not limited thereto.

Since the nonylphenyl-free reactive emulsifier is a reactive surfactant including polymeric free radicals in its molecular structure, the nonylphenyl-free reactive emulsifier can be polymerized to produce stable resin latex, and does not need to select specific raw material monomers. Furthermore, the nonylphenyl-free reactive emulsifier can improve physical characteristics (such as water resistance, adhesion, weatherability, and heat resistance) of the resin material.

In some embodiments of the present disclosure, the nonylphenyl-free reactive emulsifier has an additional number of moles of ethylene oxide (EO) between 10 and 20, a purity between 10% and 25%, a hue (APHA) between 2(G) and 5(G), a pH value between 6.5 and 7.5, and a viscosity not greater than 12,000 (mPas, 25° C.), but the present disclosure is not limited thereto.

Furthermore, the acrylic monomers include: a first acrylic monomer, a second acrylic monomer, a third acrylic monomer, and a fourth acrylic monomer. The first acrylic monomer is an alkyl-containing (meth)acrylate. The second acrylic monomer is a hydroxyl-containing (meth)acrylate. The third acrylic monomer is a carboxyl-containing (meth)acrylate. The fourth acrylic monomer is an ethylenically-unsaturated-functional-group s-containing (meth)acrylate. It is worth mentioning that the above-mentioned acrylic monomers are formed into an acrylic resin after a co-polymerization reaction. The acrylic resin is a matrix material of the water-based acrylic resin, and a content of the acrylic resin in the water-based acrylic resin is greater than 50 wt %.

The first acrylic monomer (alkyl-containing (meth)acrylate) is selected from a group consisting of methyl methacrylate (MMA), n-butyl-methyl acrylate (n-BMA), 2-ethylhexyl ester (2-EHA), and butyl acrylate (BA).

The second acrylic monomer (hydroxyl-containing (meth)acrylate) is 2-hydroxyethyl methacrylate (2-HEMA).

The third acrylic monomer (carboxyl-containing (meth)acrylate) is selected from a group consisting of acrylic acid (AA) and methacrylic acid (MAA).

The fourth acrylic monomer (ethylenically-unsaturated-functional-groups-containing (meth)acrylate) is selected from a group consisting of styrene (SM) and isobornyl methacrylate (IBOMA).

Furthermore, the acrylic polyol is a hydroxyl-containing polyester acrylic polyol and/or a hydroxyl-containing polyether acrylic polyol.

For example, the acrylic polyol can be at least one of SPECFLEX™ NC 701, VORALUX™ HF 4001, VORALUX™ HN 395, VORALUX™ WH 4043, VORANOL™ 4053, and VORANOL™ CP 6001 sold by Dow Chemical Company.

In addition, an acid value (KOH) of the acrylic polyol is preferably between 20 mg KOH/g and 35 mg KOH/g, and is more preferably between 21 KOH/g and 31 KOH/g. A weight average molecular weight (Mw) of the acrylic polyol is preferably between 3,000 and 12,000, and is more preferably between 4,000 and 10,000, but the present disclosure is not limited thereto.

In some embodiments of the present disclosure, a weight ratio of the acrylic monomers (including the first to fourth acrylic monomers), the acrylic polyol, and the reactive emulsifier is between 15 to 20:1 to 2:1 to 2.

According to material selections of the above-mentioned acrylic monomers and acrylic polyols, the molecular structure of the water-based acrylic resin can have polar groups such as hydroxyl (—OH) and ester groups (—COOR), thereby improving a cross-linking degree and cohesion of the resin material. Therefore, the water-based acrylic resin can have good bending resistance, so as to allow for a wide range of applications.

Furthermore, the initial reaction material includes deionized water, sodium bicarbonate, and anionic emulsifier. The anionic emulsifier is sodium dodecyl benzene sulfonate (SDBS), which is different from the nonylphenyl-free reactive emulsifier in the above-mentioned polymerizable composition.

Furthermore, the first hydrophilic initial aqueous solution includes deionized water and sodium persulfate (SPS).

In addition, the second hydrophilic initial aqueous solution also includes deionized water and sodium persulfate (SPS).

The first hydrophilic initial aqueous solution and the second hydrophilic initial aqueous solution include roughly the same types of materials. The difference is that addition sequences of the first hydrophilic initial aqueous solution and the second hydrophilic initial aqueous solution in the polymerization reaction are different, and an amount of the deionized water in the first hydrophilic initial aqueous solution and the second hydrophilic initial aqueous solution are also different. The polymerization reaction of the embodiment of the present disclosure will be described in more detail below.

### Method for Producing Water-Based Acrylic Resin

The above is the relevant description of the water-based acrylic resin according to the embodiment of the present disclosure, and a method for producing a water-based acrylic resin will be described below according to Examples 1 to 3 of the present disclosure.

The embodiment of the present disclosure also provides a method for producing a water-based acrylic resin. The method for producing the water-based acrylic resin includes step S110, step S120, step S130, step S140, and step S150. It should be noted that the sequence of the steps and the actual operation way described in the present embodiment can be adjusted according to requirements, and are not limited to those described in the present embodiment.

The step S110 includes: adding 70 parts by weight to 90 parts by weight (preferably 80 parts by weight) of deionized water, 0.5 parts by weight to 0.9 parts by weight (preferably 0.7 parts by weight) of sodium bicarbonate, and 1 part by weight to 5 parts by weight (preferably 3 parts by weight) of an anionic emulsifier (i.e., sodium dodecyl benzene sulfonate, SDBS) into a first reaction tank and stirring uniformly to form an initial reaction material.

The step S120 includes: increasing a temperature of the initial reaction material in the first reaction tank to a first heating temperature between 74° C. and 78° C. (preferably 76° C.), adding a first hydrophilic initial aqueous solution formed by 0.1 parts by weight to 0.3 parts by weight (preferably 0.2 parts by weight) of sodium persulfate (SPS) and 1 part by weight to 5 parts by weight (preferably 3 parts by weight) of deionized water into the initial reaction material, and then continuously stirring the same for 20 minutes.

The step S130 includes: using a blender to uniformly mix 30 parts by weight to 50 parts by weight (preferably 41 parts by weight) of deionized water, 1 part by weight to 3 parts by weight (preferably 2 parts by weight) of a reactive emulsifier (i.e., nonylphenyl-free reactive emulsifier SR-10), a first acrylic monomer (alkyl-containing (meth)acrylate), a second acrylic monomer (hydroxyl-containing (meth)acrylate), a third acrylic monomer (carboxyl-containing (meth)acrylate), a fourth acrylic monomer (ethylenically-unsaturated-functional-groups-containing (meth)acrylate), and an acrylic polyol (hydroxyl-containing polyester acrylic polyol and/or hydroxyl-containing polyether acrylic polyol) according to a predetermined ratio, so as to form a pre-emulsion. The formula and dosage of each component in Examples 1 to 3 are shown in Table 1 below.

The total amount of the pre-emulsion is approximately between 210 parts by weight to 250 parts by weight (preferably 230 parts by weight).

It should be noted that disclosures involving compositions are often expressed in two different ways, namely, in the “parts by weight” notation or in the “percent by weight (wt %)” notation. The “parts by weight” notation of a composition reflects a proportional relationship between components in the composition. The “weight percentage (wt %)” notation, on the other hand, has to meet limits of “upper and lower limit formulas” and “a sum of percentages of the components in the composition being equal to 100”, while the “parts by weight” notation does not. The upper and lower limit formulas are that: an upper limit of a content of a single component plus lower limits of contents of the remaining components must be less than or equal to 100 wt %, and a lower limit of a content of a single component plus upper limits of contents of the remaining components must be greater than or equal to 100 wt %. Therefore, if the “parts by weight” notation is converted into the “percent by weight (wt %)” notation, this represents that a percentage based on a total of 100% is provided and the limits of “upper and lower limit formulas” must be observed. An example of such a conversion is described as follows. A composition includes 50 parts by weight of A and 20 parts by weight of B. After the conversion, the composition includes 50/(50+20) weight percentage of A and 20/(50+20) weight percentage of B. For example, in the embodiment of the present disclosure, an amount of the above-mentioned reactive emulsifier is between 1 part by weight and 3 parts by weight. The conversion of parts by weight to percentage by weight means that 1 part by weight to 3 parts by weight are divided by 230 parts by weight, thereby obtaining 0.43 weight percentage (wt %) to 1.30 weight percentage (wt %) based on the pre-emulsion being 100 weight percentage (wt %).

The step S140 includes: taking 10 parts by weight to 30 parts by weight (preferably 20 parts by weight) of the pre-emulsion from the first reaction tank, adding the pre-emulsion into a second reaction tank, and reacting for 10 minutes to 50 minutes (preferably 30 minutes) to form a seed emulsion.

The step S150 includes: maintaining the seed emulsion at the first heating temperature (74° C. to 78° C.), and adding the remaining pre-emulsion into the second reaction tank in a droplet manner. After reacting for 2 hours, a second hydrophilic initial aqueous solution formed by 0.1 parts by weight to 0.3 parts by weight (preferably 0.2 parts by weight) of sodium persulfate (SPS) and 30 parts by weight to 40 parts by weight (preferably 35 parts by weight) of deionized water is added into the second reaction tank in the droplet manner. A dripping time is controlled to be within 2 hours, a temperature of the seed emulsion in the second reaction tank is raised to a second heating temperature between 78° C. to 82° C. (preferably 80° C.), and a reaction time is 0.5 hours to 1.5 hours (preferably 1 hour). Then, the temperature of the seed emulsion in the second reaction tank is lowered to a cooling temperature below 40° C., which is followed by adding ammonia water into the seed emulsion to obtain a resulting product. A pH value of the resulting product is adjusted to 7-8, and the resulting product is finally cooled to a room temperature, so as to obtain the water-based acrylic resin.

The water-based acrylic resin is in a form of emulsion, a solid content of the water-based acrylic resin is between 30% and 50% by weight, and an average particle size of the water-based acrylic resin is between 105 nanometers and 115 nanometers, but the present disclosure is not limited thereto.

Finally, the water-based acrylic resin is coated on an artificial leather to obtain a test sample, and physical properties of the test sample are measured. Test results are shown in Table 1.

Regarding the test results, the test sample (4.5 CM*7 CM) is mounted on a tortuosity testing machine, and a tortuous test is performed on the test sample at an angle of 22.5°, a frequency of 100 times per minute for 300 minutes, and a temperature of 25° C. or −30° C. Then, an observation is made as to whether a surface of the test sample is damaged, wrinkled, or cracked. The experimental data are shown in Table 1.

TABLE 1
production parameters and test results of water-based acrylic resin

| | | | | | | | Comparative |
|---|---|---|---|---|---|---|---|
| composition | | | | Example 1 | Example 2 | Example 3 | Example 1 |
| initial reaction | deionized water (parts by weight) | | | 80 | 80 | 80 | 80 |
| material | sodium bicarbonate (parts by weight) | | | 0.7 | 0.7 | 0.7 | 0.7 |
| | SDBS (anionic emulsifier) (parts by weight) | | | 3 | 3 | 3 | 3 |
| 1st hydrophilic | deionized water (parts by weight) | | | 3 | 3 | 3 | 3 |
| initial aqueous | sodium persulfate SPS (parts by weight) | | | 0.2 | 0.2 | 0.2 | 0.2 |
| solution | | | | | | | |
| polymerizable | deionized water (parts by weight) | | | 41 | 41 | 41 | 41 |
| composition | reactive emulsifier | | SR-10 (parts by weight) | 2 | 2 | 2 | — |
| | | | PC-10 (parts by weight) | — | — | — | 2 |
| | monomers | (A) | MMA (parts by weight) | 28 | 28 | 28 | 31 |
| | | alkyl-containing | n-BMA (parts by weight) | 11 | 11 | 11 | 15 |
| | | (meth)acrylate | 2-EHA (parts by weight) | 12 | 12 | 12 | 12 |
| | | | BA (parts by weight) | 8 | 8 | 8 | 8 |
| | | (B) | 2-HEMA (parts by weight) | 18 | 18 | 18 | 18 |
| | | hydroxyl-containing | | | | | |
| | | (meth)acrylate | | | | | |
| | | (C) | AA (parts by weight) | 4 | 4 | 4 | 4 |
| | | carboxyl-containing | MAA (parts by weight) | 4 | 4 | 4 | 4 |
| | | (meth)acrylate | | | | | |
| | | (D) | SM (parts by weight) | 5 | 5 | 5 | 5 |
| | | ethylenically- | IBOMA (parts by weight) | 3 | 3 | 3 | 3 |
| | | unsaturated- | | | | | |
| | | functional-groups- | | | | | |
| | | containing | | | | | |
| | | (meth)acrylate | | | | | |
| | | (E) | SPECFLEX ™ NC701 | 7 | | 3.5 | |
| | | hydroxyl-containing | (parts by weight) | | | | |
| | | polyester acrylic | VORALUX ™ HF | — | 7 | 3.5 | — |
| | | polyol and/or | 4001 (parts by weight) | | | | |
| | | hydroxyl-containing | | | | | |
| | | polyether acrylic | | | | | |
| | | polyol | | | | | |

| | | | | | |
|---|---|---|---|---|---|
| second | deionized water (parts by weight) | 35 | 35 | 35 | 35 |
| hydrophilic | sodium persulfate SPS (parts by weight) | 0.2 | 0.2 | 0.2 | 0.2 |
| initial aqueous | | | | | |
| solution | | | | | |
| resin | appearance | milky | milky | milky | milky |
| | | white | white | white | white |
| | solid content (%) | 40 | 40 | 40 | 40 |
| | average particle size (nm) | 108 | 111 | 115 | 118 |
| test results | 25° C., tortuous resistance (100,000 times) | no damage | no damage | no damage | damaged |
| | low temperature −30° C., tortuous | no damage | no damage | no damage | damaged |
| | resistance (30,000 times) | | | | |

The production parameters of the water-based acrylic resins in the foregoing Examples 1 to 3 are approximately the same. The difference is the type and amount of the acrylic polyol that is added. Furthermore, the difference between Comparative Example 1 and Examples 1 to 3 is that Comparative Example 1 does not include acrylic polyol, and the reactive emulsifier of Comparative Example 1 is PC-10 instead of nonylphenyl-free reactive emulsifier SR-10. In terms of the test results, the tortuosity resistance of each of Examples 1 to 3 is better than that of Comparative Example 1.

### BENEFICIAL EFFECTS OF THE EMBODIMENTS

In conclusion, in the water-based acrylic resin and the method for producing the same provided by the present disclosure, through a material selection of the polymerizable composition, the water-based acrylic resin has good flex resistance and a low amount of volatile organic compound (VOC) emission.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A water-based acrylic resin comprising a polymerizable composition, wherein the polymerizable composition includes:
deionized water;
a reactive emulsifier, which is a nonylphenyl-free reactive emulsifier;
a plurality of acrylic monomers including:
a first acrylic monomer, which is an alkyl-containing (meth)acrylate;
a second acrylic monomer, which is a hydroxyl-containing (meth)acrylate;
a third acrylic monomer, which is a carboxyl-containing (meth)acrylate; and
a fourth acrylic monomer, which is an ethylenically-unsaturated-functional-groups-containing (meth)acrylate; and
an acrylic polyol, which is one or both of a hydroxyl-containing polyester acrylic polyol and a hydroxyl-containing polyether acrylic polyol;
wherein the water-based acrylic resin is in a form of emulsion, and a solid content of the water-based acrylic resin is between 30% and 50% by weight.

2. The water-based acrylic resin according to claim 1, wherein the nonylphenyl-free reactive emulsifier is at least one of SR-10, SR-20, and SR-1025 sold by ADEKA Corporation.

3. The water-based acrylic resin according to claim 1, wherein the nonylphenyl-free reactive emulsifier has an additional number of moles of ethylene oxide (EO) between 10 and 20, a purity between 10% and 25%, a hue (APHA) between 2(G) and 5(G), a pH value between 6.5 and 7.5, and a viscosity not greater than 12,000 (mPas, 25° C.).

4. The water-based acrylic resin according to claim 1, wherein the first acrylic monomer, the second acrylic monomer, the third acrylic monomer, and the fourth acrylic monomer are formed into an acrylic resin after a polymerization reaction, and the acrylic resin is a main matrix material of the water-based acrylic resin.

5. The water-based acrylic resin according to claim 1, wherein the first acrylic monomer is selected from a group consisting of methyl methacrylate (MMA), n-butyl-methyl acrylate (n-BMA), 2-ethylhexyl ester (2-EHA), and butyl acrylate (BA); wherein the second acrylic monomer is 2-hydroxyethyl methacrylate (2-HEMA); wherein the third acrylic monomer is selected from a group consisting of acrylic acid (AA) and methacrylic acid (MAA); wherein the fourth acrylic monomer is selected from a group consisting of styrene (SM) and isobornyl methacrylate (IBOMA).

6. The water-based acrylic resin according to claim 1, wherein the acrylic polyol is at least one of SPECFLEX™ NC 701, VORALUX™ HF 4001, VORALUX™ HN 395, VORALUX™ WH 4043, VORANOL™ 4053, and VORANOL™ CP 6001 sold by Dow Chemical Company.

7. The water-based acrylic resin according to claim 1, wherein an acid value (KOH) of the acrylic polyol is between 20 mg KOH/g and 35 mg KOH/g, and a weight average molecular weight (Mw) of the acrylic polyol is between 3,000 and 12,000.

8. The water-based acrylic resin according to claim 1, wherein a weight ratio of the plurality of acrylic monomers, the acrylic polyol, and the reactive emulsifier is between 15 to 20:1 to 2:1 to 2.

9. The water-based acrylic resin according to claim 1, wherein a molecular structure of the water-based acrylic resin has a polar group, and the polar group is one or both of a hydroxyl group (—OH) and an ester group (—COOR).

10. The water-based acrylic resin according to claim 1, wherein the water-based acrylic resin is configured to be coated on an artificial leather to obtain a test sample, the test sample is then mounted on a flex testing machine, and a flex test is performed on the test sample at an angle of 22.5° and a frequency of 100 times per minute for 300 minutes; wherein the test sample is free of damage after the flex test.

11. A method for producing a water-based acrylic resin, comprising:
adding and uniformly stirring deionized water, sodium bicarbonate, and sodium dodecyl benzene sulfonate in a first reaction tank, so as to form an initial reaction material;
heating the initial reaction material to a first heating temperature, and then adding a first hydrophilic initial aqueous solution formed by sodium persulfate and deionized water into the initial reaction material;
adding and uniformly mixing deionized water, nonylphenyl-free reactive emulsifier, alkyl-containing (meth)acrylate, hydroxyl-containing (meth)acrylate, carboxyl-containing (meth)acrylate, ethylenically-unsaturated-functional-groups-containing (meth)acrylate, and one or both of hydroxyl-containing polyester acrylic polyol and hydroxyl-containing polyether acrylic polyol with the initial reaction material in the first reaction tank, so as to form a pre-emulsion;
taking a part of the pre-emulsion from the first reaction tank and adding the part of the pre-emulsion into a second reaction tank, so as to form a seed emulsion; and
maintaining the seed emulsion at the first heating temperature, and adding another part of the pre-emulsion into the second reaction tank to react in a dropwise manner, wherein a second hydrophilic initial aqueous solution formed by sodium persulfate and deionized water is added into the second reaction tank in the droplet manner, a temperature of the seed emulsion is sequentially raised to a second heating temperature and lowered to a cooling temperature, and then a pH value of the seed emulsion is adjusted to obtain the water-based acrylic resin.

12. The method according to claim 11, wherein the first heating temperature is between 74° C. and 78° C., the second heating temperature is between 78° C. and 82° C., and the cooling temperature is not greater 40° C.
